(19) United States
(12) Patent Application Publication
(10) Pub. No.: US 2026/0104492 A1
(43) Pub. Date: Apr. 16, 2026

(54) SURVEYING INSTRUMENT

(71) Applicant: TOPCON CORPORATION, Tokyo-to (JP)

(72) Inventor: Taichi Yuasa, Tokyo-to (JP)

(21) Appl. No.: 19/354,970

(22) Filed: Oct. 10, 2025

(30) Foreign Application Priority Data
Oct. 16, 2024 (JP) 2024-180446

(51) Int. Cl. G01S 7/481; G01S 17/42; G01S 17/66

(52) U.S. Cl. CPC G01S 7/4817; G01S 17/42; G01S 17/66

(57) ABSTRACT

A surveying instrument comprises a distance measuring light projecting module which projects a distance measuring light to an object, a distance measuring light receiving module having a light receiving module which receives a reflected distance measuring light from the object, and an arithmetic control module which controls the distance measuring light projecting module and calculates a distance to the object based on a light receiving result of the reflected distance measuring light with respect to the light receiving module, wherein the distance measuring light receiving module has a light receiving lens which focuses the reflected distance measuring light, and a reflection mirror provided oppositely to the light receiving lens, a reflection surface is formed at a center part of a surface opposing the reflection mirror of the light receiving lens, and the reflected distance measuring light transmitted through the light receiving lens is reciprocatingly reflected by the reflection mirror and the reflection surface along an optical axis of the reflected distance measuring light.

### BACKGROUND OF THE INVENTION

The present invention relates to a surveying instrument capable of acquiring three-dimensional coordinates of an object.

The surveying instrument such as a laser scanner, a total station and the like has an electronic distance meter which detects a distance to an object by a prism distance measurement using a prism with a retro-reflectivity as an object and non-prism distance measurement not using a reflection prism.

A light receiving module of an electronic distance meter has an optical system including a lens and is constituted such that a reflected distance measuring light focuses on a light receiving surface by a refraction action of the lens. An object lens of the optical system has a focal distance “f”, and the light receiving module needs a size capable of accommodating the optical system, and a length in an optical axis direction capable of ensuring the focal distance “f”. Therefore, it is difficult to reduce a size of the light receiving module due to a size of an optical system and restriction of the focal distance.

### SUMMARY OF THE INVENTION

It is an object of the present invention to provide a surveying instrument which reduces a size of an optical system and promotes size reduction of the entire device.

To attain the object as described above, a surveying instrument according to the present invention comprises a distance measuring light projecting module which projects a distance measuring light to an object, a distance measuring light receiving module having a light receiving module which receives a reflected distance measuring light from the object, and an arithmetic control module which controls the distance measuring light projecting module and calculates a distance to the object based on a light receiving result of the reflected distance measuring light with respect to the light receiving module, wherein the distance measuring light receiving module has a light receiving lens which focuses the reflected distance measuring light, and a reflection mirror provided oppositely to the light receiving lens, a reflection surface is formed at a center part of a surface opposing the reflection mirror of the light receiving lens, and the reflected distance measuring light transmitted through the light receiving lens is reciprocatingly reflected by the reflection mirror and the reflection surface along an optical axis of the reflected distance measuring light.

Further, the surveying instrument according to a preferred embodiment further has a light receiving reflection prism provided on the reflection mirror, wherein the light receiving reflection prism is configured to deflect the reflected distance measuring light reflected by the reflection surface at a right angle or substantially at a right angle.

Further, in the surveying instrument according to a preferred embodiment, the reflection mirror further has a hole formed at a center part, and the reflected distance measuring light reflected by the reflection surface passes through the hole.

Further, the surveying instrument according to a preferred embodiment further has a scanning mirror which rotationally irradiates the distance measuring light, a deflection optical member which deflects the distance measuring light such that the distance measuring light coincides with a rotation axis of the scanning mirror, and a plane-parallel plate provided on a side closer to the scanning mirror than the light receiving lens, wherein the deflection optical member is configured to be joined to a surface on a side of the scanning mirror of the plane-parallel plate.

Further, the surveying instrument according to a preferred embodiment further has a scanning mirror which rotationally irradiates the distance measuring light, a deflection optical member which deflects the distance measuring light such that the distance measuring light coincides with a rotation axis of the scanning mirror, and a plane-parallel plate provided closer to a side of the scanning mirror than the light receiving lens, wherein the deflection optical member is configured to be joined to a surface on a side of the light receiving lens of the plane-parallel plate.

Further, the surveying instrument according to a preferred embodiment further includes a tracking light projecting module which projects a tracking light to the object coaxially with the distance measuring light and a tracking light receiving module having a tracking photodetector which receives a reflected tracking light reflected from the object coaxially with the reflected distance measuring light, wherein a dichroic prism having a separation surface which separates the reflected distance measuring light and the reflected tracking light is disposed on a reflection optical axis of the light receiving reflection prism.

Further, the surveying instrument according to a preferred embodiment further includes a tracking light projecting module which projects a tracking light to the object coaxially with the distance measuring light and a tracking light receiving module having a tracking photodetector which receives a reflected tracking light reflected from the object coaxially with the reflected distance measuring light, wherein the light receiving reflection prism is a dichroic prism having a separation surface which separates the reflected distance measuring light and the reflected tracking light.

Further, the surveying instrument according to a preferred embodiment further includes a tracking light projecting module which projects a tracking light to the object coaxially with the distance measuring light and a tracking light receiving module having a tracking photodetector which receives a reflected tracking light reflected from the object coaxially with the reflected distance measuring light, wherein a dichroic prism having a separation surface which separates the reflected distance measuring light and the reflected tracking light is disposed on optical axes of the reflected distance measuring light and the reflected tracking light passing through the hole.

Further, the surveying instrument according to a preferred embodiment further has a scanning mirror which rotationally irradiates the distance measuring light and a deflection optical member which deflects the distance measuring light such that the distance measuring light coincides with a rotation axis of the scanning mirror, wherein a planar part is formed at a center part of an incident surface of the light receiving lens, and the deflection optical member is joined to the planar part.

Further, the surveying instrument according to a preferred embodiment further has a scanning mirror which rotationally irradiates the distance measuring light and a deflection optical member which deflects the distance measuring light such that the distance measuring light coincides with a rotation axis of the scanning mirror, wherein a hole is formed at a center part of an incident surface of the light receiving lens, and the deflection optical member is joined to the hole.

Furthermore, in the surveying instrument according to a preferred embodiment, the deflection optical member is a cylindrical mirror having a cylinder part in which an image pickup module having an image pickup optical axis which is coaxial with the distance measuring light is incorporated and a dichroic mirror which reflects the distance measuring light and transmits a visible light.

According to the present invention, the surveying instrument comprises a distance measuring light projecting module which projects a distance measuring light to an object, a distance measuring light receiving module having a light receiving module which receives a reflected distance measuring light from the object, and an arithmetic control module which controls the distance measuring light projecting module and calculates a distance to the object based on a light receiving result of the reflected distance measuring light with respect to the light receiving module, wherein the distance measuring light receiving module has a light receiving lens which focuses the reflected distance measuring light, and a reflection mirror provided oppositely to the light receiving lens, a reflection surface is formed at a center part of a surface opposing the reflection mirror of the light receiving lens, and the reflected distance measuring light transmitted through the light receiving lens is reciprocatingly reflected by the reflection mirror and the reflection surface along an optical axis of the reflected distance measuring light. As a result, it is possible to reduce a length in an optical axis direction of the reflected distance measuring light, and it is possible to promote a size reduction of an optical system and a size reduction of an entire device.

### BRIEF DESCRIPTION OF THE DRAWINGS

FIG. 1 is a front cross-sectional diagram illustrating a surveying instrument according to a first embodiment.

FIG. 2 is a schematic diagram illustrating a distance measuring module according to a first embodiment.

FIG. 3 is a schematic diagram illustrating a distance measuring module according to a second embodiment.

FIG. 4 is a schematic diagram illustrating a distance measuring module according to a third embodiment.

FIG. 5 is a schematic diagram illustrating a distance measuring module according to a fourth embodiment.

FIG. 6 is a schematic diagram illustrating a distance measuring module according to a fifth embodiment.

FIG. 7A is a schematic diagram illustrating a distance measuring module according to a first variation, and FIG. 7B is a schematic diagram illustrating a distance measuring module according to a second variation.

FIG. 8A is a schematic diagram illustrating a distance measuring module according to a third variation, and FIG. 8B is a schematic diagram illustrating a distance measuring module according to a fourth variation.

FIGS. 9A and 9B are explanatory drawing illustrating a light receiving lens, respectively, and FIG. 9C is an explanatory drawing illustrating a variation of a deflection optical member.

### DETAILED DESCRIPTION OF THE PREFERRED EMBODIMENTS

A description will be given below on embodiments of the present invention by referring to the attached drawings.

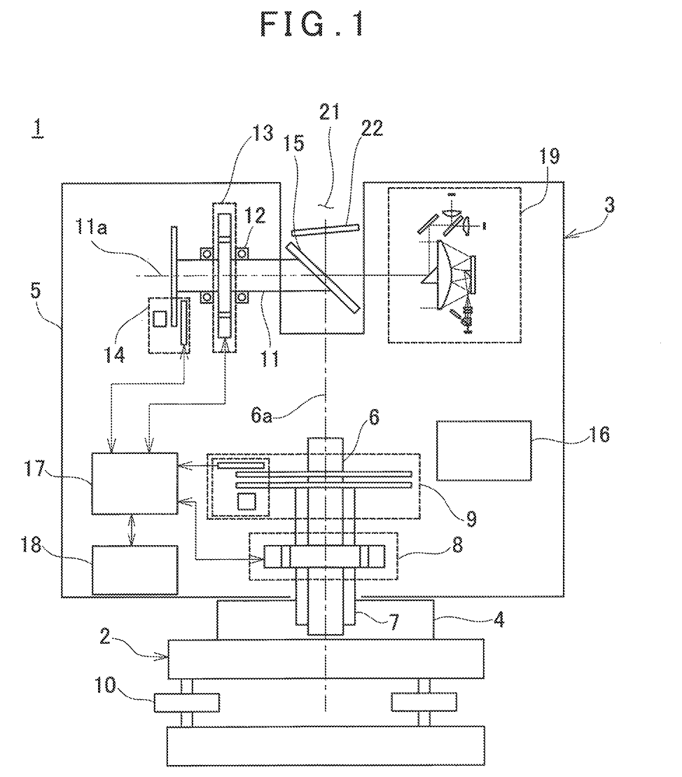

First, in FIG. 1, a description will be given on a surveying instrument according to a first embodiment of the present invention.

A surveying instrument 1 is, for instance, a laser scanner, and is constituted by a leveling module 2 mounted on a tripod (not shown) and a surveying instrument main body 3 mounted on the leveling module 2.

The leveling module 2 has a leveling screw 10 and performs leveling of the surveying instrument main body 3 to a horizontal by the leveling screw 10.

The surveying instrument main body 3 includes (accommodates) a fixing unit 4, a frame unit 5, a horizontal rotation shaft 6, a horizontal rotation bearing 7, a horizontal rotation motor 8 as a horizontal rotation driver, a horizontal angle encoder 9 as a horizontal angle detector, a vertical rotation shaft 11, a vertical rotation bearing 12, a vertical rotation motor 13 as a vertical rotation driver, a vertical angle encoder 14 as a vertical angle detector, a scanning mirror 15, an operation panel 16 serving both as an operation module and a display module, an arithmetic control module 17, a storage module 18, a distance measuring module 19 and the like. It is to be noted that, as the arithmetic control module 17, a CPU specialized for this instrument or a general-purpose CPU is used.

The horizontal rotation bearing 7 is fixed to the fixing unit 4. The horizontal rotation shaft 6 has a vertical axis 6a, and the horizontal rotation shaft 6 is rotatably supported by the horizontal rotation bearing 7. Further, the frame unit 5 is supported by the horizontal rotation shaft 6, and the frame unit 5 is configured to be rotated in the horizontal direction integrally with the horizontal rotation shaft 6.

Between the horizontal rotation bearing 7 and the frame unit 5, the horizontal rotation motor 8 is provided, and the horizontal rotation motor 8 is controlled by the arithmetic control module 17. The arithmetic control module 17 causes the frame unit 5 to be rotated around the axis 6a by the horizontal rotation motor 8.

A relative rotation angle of the frame unit 5 with respect to the fixing unit 4 is detected by the horizontal angle encoder 9. A detection signal from the horizontal angle encoder 9 is input into the arithmetic control module 17, and a horizontal angle data is calculated by the arithmetic control module 17. The arithmetic control module l7 performs a feedback control with respect to the horizontal rotation motor 8 based on the horizontal angle data.

Further, in the frame unit 5, the vertical rotation shaft 11 having a horizontal axis 11a is provided. The vertical rotation shaft 11 is rotatable via the vertical rotation bearing 12. It is to be noted that an intersection of the axis 6a and the axis 11a is a projection position of a distance measuring light and is an origin of a coordinate system of the surveying instrument main body 3.

In the frame unit 5, a recess portion 21 is formed. The vertical rotation shaft 11 has one end part extending into the recess portion 21, the scanning mirror 15 is fixed to the one end part, and the scanning mirror 15 is accommodated in the recess portion 21. Further, at the other end part of the vertical rotation shaft 11, the vertical angle encoder 14 is provided.

At a position on the axis 6a and opposing the scanning mirror 15, a window portion 22 formed of a transparent material such as a glass or the like and rotating integrally with the scanning mirror 15 is provided. The window portion 22 is tilted by a predetermined angle with respect to the axis 6a. It is to be noted that the scanning mirror 15 and the window portion 22 constitute a vertical rotation unit integrally rotated in a vertical direction via the vertical rotation shaft 11 by the vertical rotation motor 13.

The vertical rotation motor 13 is provided on the vertical rotation shaft 11, and the vertical rotation motor 13 is controlled by the arithmetic control module 17. The arithmetic control module 17 causes the vertical rotation shaft 11 to be rotated by the vertical rotation motor 13, and the scanning mirror 15 is rotated around the axis 11a.

A rotation angle of the scanning mirror 15 is detected by the vertical angle encoder 14, and a detection signal is input into the arithmetic control module 17. The arithmetic control module 17 calculates a vertical angle data of the scanning mirror 15 based on the detection signal, and performs a feedback control with respect to the vertical rotation motor 13 based on the vertical angle data.

Further, a horizontal angle data, a vertical angle data, and measurement results calculated by the arithmetic control module 17 are stored in the storage module 18. As the storage module 18, various storage devices such as an HDD as a magnetic storage device, a CD, a DVD as an optical storage device, a memory card as a semiconductor storage device, a USB memory are used. The storage module 18 may be detachably attached to the frame unit 5 or may be capable of sending a data to an external storage device and an external data processing device via a communication means, not shown.

In the storage module 18, various types of programs such as a sequence program for controlling a distance measuring operation, a calculation program for calculating a distance by a distance measuring operation, a calculation program for calculating an angle based on a horizontal angle data and a vertical angle data, a calculation program for calculating a three-dimensional coordinate of a desired measuring point based on a distance and an angle, are stored. Further, when the various types of programs are performed by the arithmetic control module 17, the various types of processing are performed.

The operation panel 16 is, for instance, a touch panel, and serves both as an operation module for instructing a distance measurement and for changing measurement conditions such as a measuring point interval, for instance, and a display module for displaying distance measurement results, images and the like.

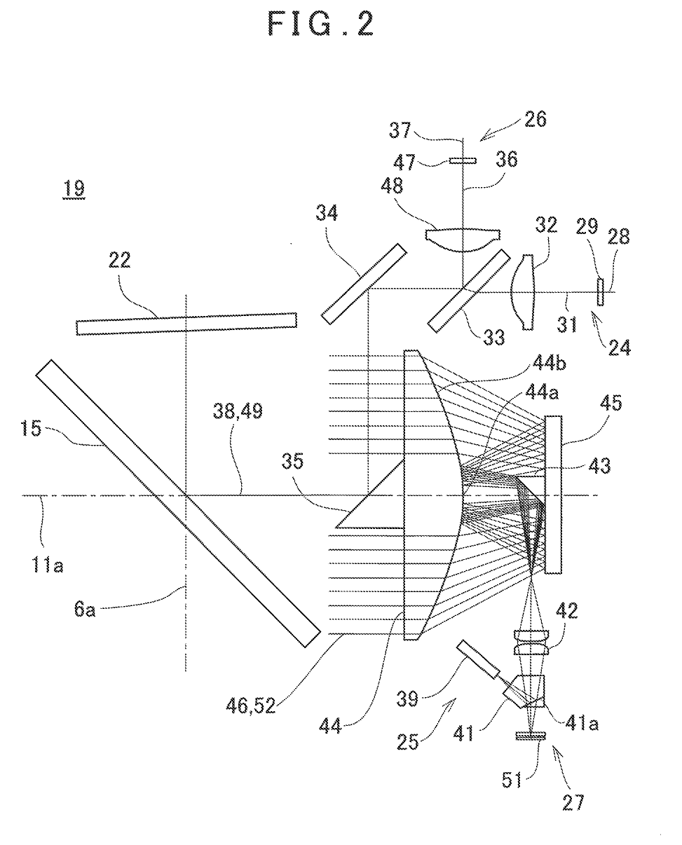

Next, a description will be given on the distance measuring module 19 by referring to FIG. 2. In a first embodiment, a light receiving lens 44 (to be described later) has a focal distance f = 110 mm, an objective effective diameter ϕ50 mm. Further, for the other embodiments, too, the similar light receiving lens 44 is used.

The distance measuring module 19 has a distance measuring light projecting module 24, a distance measuring light receiving module 25, a tracking light projecting module 26, and a tracking light receiving module 27. It is to be noted that a distance measuring unit is constituted by the distance measuring light projecting module 24 and the distance measuring light receiving module 25, and a tracking module is constituted by the tracking light projecting module 26 and the tracking light receiving module 27.

The distance measuring light projecting module 24 has a distance measuring optical axis 28. Further, the distance measuring light projecting module 24 has, in an order from a light emission side, a light emitter 29 such as a laser diode (LD), for instance, projecting a near-infrared light with a predetermined wavelength as a distance measuring light 31, a projecting lens 32, a dichroic mirror 33 provided on the distance measuring optical axis 28, and a mirror 34 provided on a transmission optical axis of the dichroic mirror 33. Further, on a reflection optical axis of the mirror 34, a deflection optical member such as a reflection prism 35, for instance, is provided, and on a reflection optical axis of the reflection prism 35, the scanning mirror 15 is provided. Further, on a reflection optical axis of the scanning mirror 15, the window portion 22 is provided.

It is to be noted that, in the present embodiment, the distance measuring optical axis 28, the distance measuring optical axis 28 reflected by the mirror 34, the distance measuring optical axis 28 reflected by the reflection prism 35, and the distance measuring optical axis 28 reflected by the scanning mirror 15 are collectively called the distance measuring optical axis 28.

The dichroic mirror 33 has an optical characteristic that transmits the distance measuring light 31 and reflects a tracking light 36 (to be described later). Further, the dichroic mirror 33 is provided on a common optical path of the distance measuring light 31 and the tracking light 36 (an intersecting position of the distance measuring optical axis 28 and a tracking optical axis 37 (to be described later)) and deflects (reflects) the tracking optical axis 37 at a right angle such that the tracking optical axis 37 coincides with the distance measuring optical axis 28. Therefore, the distance measuring light 31 and the tracking light 36 are emitted coaxially toward an object.

The reflection prism 35 is configured to deflect (reflect) such that the distance measuring optical axis 28 and the tracking optical axis 37 coincide with a light receiving optical axis 38 (to be described later) and the axis 11a. As for a reflection surface of the reflection prism 35, an inclination angle may be 45° such that the distance measuring light 31 and the tracking light 36 are reflected at a right angle or may be those other than 45°. An inclination angle of a reflection surface of the reflection prism 35 is designed as appropriate in a range of approximately 40° to 50°, for instance. It is to be noted that the reflection prism 35 may be a triangular prism as shown in FIG. 2 or may be a cylindrical mirror.

The distance measuring light receiving module 25 has the light receiving optical axis 38. Further, the distance measuring light receiving module 25 has, in an order from a light receiving side, a light receiving fiber 39 as a light receiving module, a dichroic prism 41 provided on the light receiving optical axis 38, a relay lens 42, a light receiving reflection prism 43 provided on a reflection optical axis of the dichroic prism 41, a light receiving lens 44 provided on a reflection optical axis of the light receiving reflection prism 43, and a reflection mirror 45 as a first reflection part provided on a reflection optical axis of the light receiving lens 44.

The light receiving fiber 39 is configured to receive a reflected distance measuring light 46 (to be described later) and to transmit a light receiving signal to the arithmetic control module 17. The dichroic prism 41 is constituted by joining two prisms, and a joined surface is a separation surface 41a in which a dichroic film is deposited. The separation surface 41a has an optical characteristic that reflects the reflected distance measuring light 46 and transmits the tracking light 36 (reflected tracking light 52) incident coaxially with the reflected distance measuring light 46. That is, the separation surface 41a functions as a separation surface which separates the reflected distance measuring light 46 and the reflected tracking light 52.

The relay lens 42 is a convex lens group constituted by a plurality of lenses and is constituted such that the reflected distance measuring light 46 is focused to a light receiving end surface of the light receiving fiber 39. The light receiving reflection prism 43 is a triangular prism, for instance, and is constituted such that the reflected distance measuring light 46 is deflected (reflected) at a right angle or substantially at a right angle toward the relay lens 42. Here, a right angle means 90° and substantially at a right angle means approximately 85° to 95° except 90°. Therefore, when it is described as at a right angle or substantially at a right angle in the following explanation, it means 85° to 95°.

The light receiving lens 44 is a lens with a predetermined Numerical Aperture (NA), and a surface (incident surface) of the scanning mirror 15 side is a plane orthogonal to the light receiving optical axis 38. Further, the light receiving reflection prism 43 side of the light receiving lens 44, that is, a surface (projection surface) on a side opposite to the scanning mirror 15 is a convex surface of an aspherical surface, an annular aspherical surface or an axially symmetrical free curved surface. Further, at a center part on the scanning mirror 15 side of the light receiving lens 44, the reflection prism 35 is mounted.

Further, to a center part on a surface of the light receiving reflection prism 43 side of the light receiving lens 44, mirror coating is applied, and a reflection surface 44a as a second reflection part is formed. On a region other than the center part of the light receiving lens 44, Anti Reflection (AR) coat is applied, and a transmission surface 44b is formed. Therefore, the reflection surface 44a is formed on a rear surface of the reflection prism 35, and a size of the reflection surface 44a is equal to or substantially equal to a bottom area of the reflection prism 35, for instance.

The reflection mirror 45 is a plate-shaped mirror, and to a center part thereof, the light receiving reflection prism 43 is joined. A size of the reflection mirror 45, for instance, is such that the entire reflected distance measuring light 46 to be transmitted through the light receiving lens 44 and to be collected can be incident in the reflection mirror 45.

It is to be noted that, in the present embodiment, the light receiving optical axis 38, the light receiving optical axis 38 reflected by the dichroic prism 41 (separation surface 41a), the light receiving optical axis 38 reflected by the light receiving reflection prism 43, the light receiving optical axis 38 reflected by the light receiving lens 44 (reflection surface 44a), the light receiving optical axis 38 reflected by the reflection mirror 45, and the light receiving optical axis 38 reflected by the scanning mirror 15 are collectively called the light receiving optical axis 38.

The tracking light projecting module 26 has the tracking optical axis 37. Further, the tracking light projecting module 26 has a tracking light emitter 47, such as a laser diode (LD) which projects a near-infrared light with a wavelength different from the distance measuring light 31, for instance, as the tracking light 36, a tracking projection lens 48, and the dichroic mirror 33 provided on the tracking optical axis 37, in an order from a light emission side and has the mirror 34 provided on a reflection optical axis of the dichroic mirror 33, and the reflection prism 35 provided on a reflection optical axis of the mirror 34.

The tracking light receiving module 27 has a tracking light receiving optical axis 49. Further, the tracking light receiving module 27 has, in an order from a light receiving side, a tracking photodetector 51, the dichroic prism 41, the relay lens 42, and the light receiving reflection prism 43 provided on the tracking light receiving optical axis 49, and also has the light receiving lens 44 provided on a reflection optical axis of the light receiving reflection prism 43 and the reflection mirror 45 provided on a reflection optical axis of the light receiving lens 44.

It is to be noted that, in the present embodiment, the tracking optical axis 37, the tracking optical axis 37 reflected by the dichroic mirror 33, the tracking optical axis 37 reflected by the mirror 34, the tracking optical axis 37 reflected by the reflection prism 35, and the tracking optical axis 37 reflected by the scanning mirror 15 are collectively called the tracking optical axis 37. Further, the tracking light receiving optical axis 49, the tracking light receiving optical axis 49 reflected by the light receiving reflection prism 43, the tracking light receiving optical axis 49 reflected by the reflection surface 44a of the light receiving lens 44, the tracking light receiving optical axis 49 reflected by the reflection mirror 45, and the tracking light receiving optical axis 49 reflected by the scanning mirror 15 are collectively called the tracking light receiving optical axis 49.

The tracking photodetector 51 is a CCD or a CMOS sensor, which is an assembly of pixels, and each pixel is configured such that it is possible to specify a position on the tracking photodetector 51. For instance, each pixel has a pixel coordinate with a center of the tracking photodetector 51 as an origin, and a position on the tracking photodetector 51 is specified by the pixel coordinate.

The distance measuring module 19 is controlled by the arithmetic control module 17. When the pulse-like distance measuring light 31 is projected from the light emitter 29 onto the distance measuring optical axis 28, the distance measuring light 31 is transmitted by the projecting lens 32, the dichroic mirror 33 and is reflected by the mirror 34. The distance measuring light 31 reflected by the mirror 34 is reflected by the reflection prism 35 and becomes coaxial with the light receiving optical axis 38 and the axis 11a. The distance measuring light 31 reflected by the reflection prism 35 is deflected to a right angle by the scanning mirror 15, transmitted through the window portion 22, and is emitted to an object. When the scanning mirror 15 rotates around the axis 11a, the distance measuring light 31 rotates (scans) in a plane which orthogonally crosses the axis 11a and includes the axis 6a.

It is to be noted that, since the window portion 22 is tilted by a predetermined angle with respect to the distance measuring optical axis 28, an incidence of the distance measuring light 31 reflected by the window portion 22 with respect to the light receiving fiber 39 is prevented. Further, a reflection position of the distance measuring light 31 on the scanning mirror 15, that is, an irradiation position of the distance measuring light 31 is a machine center of the surveying instrument 1, and the machine center is located on the axis 6a.

The reflected distance measuring light 46 reflected by an object is transmitted through the window portion 22, reflected by the scanning mirror 15 at a right angle, and is incident into the distance measuring light receiving module 25. That is, the reflected distance measuring light 46 passes through a periphery of the reflection prism 35, is incident into the light receiving lens 44, and while the reflected distance measuring light 46 is collected, is transmitted through the transmission surface 44b, and is incident into the reflection mirror 45.

Further, the reflected distance measuring light 46 is reflected toward the light receiving lens 44 opposing the reflection mirror 45 by the reflection mirror 45 and then is reflected toward the light receiving reflection prism 43 mounted on the reflection mirror 45 by a reflection surface 44a of the light receiving lens 44. That is, the reflected distance measuring light 46 is alternately (in a left-right direction with respect to a paper surface in FIG. 2) reflected along the axis 11a (the light receiving optical axis 38). Further, the reflected distance measuring light 46 is reflected at a right angle by the light receiving reflection prism 43 and then, is incident into the dichroic prism 41 via the relay lens 42, is reflected by the separation surface 41a, is incident into a light receiving end surface of the light receiving fiber 39, and a light receiving signal is sent out to the arithmetic control module 17.

The arithmetic control module 17 performs a distance measurement per pulse of the distance measuring light 31 (Time Of Flight) based on a time difference between a light emitting timing of the light emitter 29 and a light receiving timing of the light receiving fiber 39 (that is, a reciprocating time of a pulsed light) and a light velocity, and calculates a distance to an object. It is to be noted that the light emitting timing of the light emitter 29, that is, a pulse interval is capable of being changed via the operation panel 16. Further, based on a distance measurement result and a horizontal angle data and a vertical angle data acquired by the horizontal angle encoder 9 and the vertical angle encoder 14, it is possible to calculate a three-dimensional coordinate of an object.

Further, while the distance measuring light 31 is projected with a predetermined pulse interval, the frame unit 5 and the scanning mirror 15 are rotated at a constant speed, respectively, and by means of cooperation of a rotation in a vertical direction of the scanning mirror 15 and a rotation of the frame unit 5 in a horizontal direction, the distance measuring light 31 is two-dimensionally scanned. Further, when a vertical angle, a horizontal angle are detected by the vertical angle encoder 14 and the horizontal angle encoder 9 at each pulsed light, it is possible to acquire a vertical angle data and a horizontal angle data. By means of the vertical angle data, the horizontal angle data and the distance measuring data, it is possible to acquire a three-dimensional coordinate of an object and point cloud data corresponding to a three-dimensional coordinate of an object.

Further, in parallel to the distance measuring operation, the tracking light 36 with a wavelength different from the distance measuring light 31 emitted from the tracking light emitter 47 is slightly dispersed by the tracking projection lens 48 and then, is deflected by the dichroic mirror 33 such that the tracking light 36 becomes coaxial with the distance measuring light 31.

The tracking light 36 emitted to an object coaxially with the distance measuring light 31 and reflected by the object, that is, the reflected tracking light 52 is transmitted through the window portion 22, is reflected by the scanning mirror 15 and then, is incident into the tracking light receiving module 27. That is, the reflected tracking light 52 is incident into the light receiving lens 44 from a periphery of the reflection prism 35 and is transmitted through the transmission surface 44b.

Further, after the reflected tracking light 52 is reflected alternately (to right and left with respect to the paper surface in FIG. 2) along the axis 11a on the reflection mirror 45 and the reflection surface 44a, the reflected tracking light 52 is reflected at a right angle by the light receiving reflection prism 43, is transmitted through the relay lens 42 and the dichroic prism 41 (the separation surface 41a) and is received by the tracking photodetector 51. It is to be noted that the reflected distance measuring light 46 and the reflected tracking light 52 are separated by the separation surface 41a. Further, by the reception of the reflected tracking light 52 to the tracking photodetector 51, it is possible to acquire a tracking image (not shown).

The arithmetic control module 17 calculates a positional deviation between a center of the tracking photodetector 51 and a light receiving position of the reflected tracking light 52 with respect to the tracking photodetector 51 and, based on the positional deviation, causes the horizontal rotation motor 8 and the vertical rotation motor 13 to be driven and tracks an object.

As described above, in the first embodiment, at the center part of a side opposite to a side where the reflection prism 35 of the light receiving lens 44 is provided, the reflection surface 44a is formed such that the reflection surface 44a opposes the reflection mirror 45 and the light receiving reflection prism 43. As a result, it is constituted such that the reflected distance measuring light 46 and the reflected tracking light 52 transmitted through the transmission surface 44b and reflected by the reflection mirror 45 are reflected by the reflection surface 44a again to the reflection mirror 45 side.

That is, between the light receiving lens 44 and the reflection mirror 45, the reflected distance measuring light 46 and the reflected tracking light 52 are reflected plural times such that the reflected distance measuring light 46 and the reflected tracking light 52 reciprocate along the light receiving optical axis 38 and the tracking light receiving optical axis 49 (the axis 11a), and optical path lengths of the reflected distance measuring light 46 and the reflected tracking light 52 are ensured.

Therefore, since there is no need to ensure an optical path length for a focal distance of the light receiving lens 44 in a direction of the light receiving optical axis 38 (the tracking light receiving optical axis 49), it is possible to reduce a length of a direction in the light receiving optical axis 38 (the tracking light receiving optical axis 49) of the distance measuring light receiving module 25 and the tracking light receiving module 27. As a result, it is possible to promote a size reduction of an optical system of the distance measuring module 19, and it is possible to promote a size reduction and a weight reduction of the entire surveying instrument 1.

Further, since the reflection surface 44a is formed on a part of the light receiving lens 44, it is possible to cause the reflected distance measuring light 46 and the reflected tracking light 52 to be reciprocatingly reflected between the light receiving lens 44 and the reflection mirror 45 without separately providing a reflection member.

Therefore, it is possible to reduce the number of components of the distance measuring light receiving module 25 and the tracking light receiving module 27, and it is possible to promote a reduction of a manufacturing cost.

Further, the reflection surface 44a is provided on a rear surface of the reflection prism 35, with the light receiving lens 44 positioned between them, and a size (an area) of the reflection surface 44a is equal to or substantially equal to a bottom area of the reflection prism 35.

Therefore, since the reflection surface 44a is formed at a position where a vignetting of the reflected distance measuring light 46 and the reflected tracking light 52 is generated by the reflection prism 35, light amounts of the reflected distance measuring light 46 and the reflected tracking light 52 are not lowered by the reflection surface 44a, but it is possible to ensure sufficient light amounts.

It is to be noted that, in the first embodiment, the separation surface 41a of the dichroic prism 41 causes the reflected distance measuring light 46 to be reflected in a plane including the axis 6a and the axis 11a, but a reflection direction is not limited thereto. For instance, each member of the distance measuring light receiving module 25 may be disposed three-dimensionally, and the reflected distance measuring light 46 may be reflected in a direction orthogonal to the plane.

Further, in the first embodiment, the light receiving fiber 39 is provided on a reflection side of the separation surface 41a, and the tracking photodetector 51 is provided on a transmission side, but the tracking photodetector 51 may be provided on the reflection side and the light receiving fiber 39 may be provided on the transmission side.

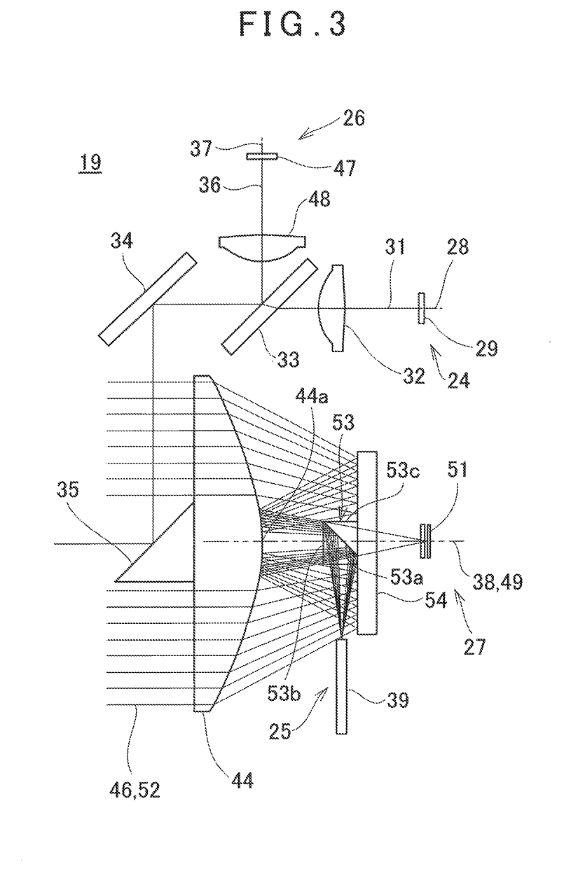

Next, in FIG. 3, a description will be given on a second embodiment of the present invention. It is to be noted that, in FIG. 3, the same components as shown in FIG. 2 are referred by the same symbols, and a description thereof will be omitted.

In a distance measuring light receiving module 25 and a tracking light receiving module 27 in the second embodiment, as a light receiving reflection prism joined to a center part of a reflection mirror 54, a dichroic prism 53 is provided. The dichroic prism 53 is constituted by joining a quadrangular prism 53b in a trapezoidal sectional shape and a triangular prism 53c, and a joined surface is a separation surface 53a to which a dichroic film is deposited. The separation surface 53a has an optical characteristic that reflects a reflected distance measuring light 46 at a right angle or substantially at a right angle toward a light receiving fiber 39 and transmits a reflected tracking light 52. That is, the separation surface 53a functions as a separation surface which separates the reflected distance measuring light 46 and the reflected tracking light 52.

Further, the reflection mirror 54 as a first reflection part is a glass plate with a reflection film formed on a surface opposing the light receiving lens 44, for instance. The reflection film is formed on a part other than spots to which the dichroic prism 53 is affixed.

Further, in the second embodiment, a relay lens 42 (see FIG. 2) or a dichroic prism 41 (see FIG. 2) is not provided, and the light receiving fiber 39 is disposed such that a light receiving end surface is located at a light collecting position of the reflected distance measuring light 46. The other configurations are similar to those in the first embodiment.

In the second embodiment, too, between the light receiving lens 44 and the reflection mirror 54, since the reflected distance measuring light 46 and the reflected tracking light 52 are reflected a plurality of times such that the reflected distance measuring light 46 and the reflected tracking light 52 reciprocate along a light receiving optical axis 38 and a tracking light receiving optical axis 49 (axis 11a), optical path lengths of the reflected distance measuring light 46 and the reflected tracking light 52 are ensured.

Therefore, since there is no need to ensure an optical path length for a focal distance of the light receiving lens 44 in a direction of the light receiving optical axis 38 (the tracking light receiving optical axis 49), it is possible to reduce a length in a direction of the light receiving optical axis 38 (the tracking light receiving optical axis 49) of the distance measuring light receiving module 25 and the tracking light receiving module 27. As a result, it is possible to promote a size reduction of an optical system of a distance measuring module 19, and a size reduction and a weight reduction of the entire surveying instrument 1.

Further, in the second embodiment, a reflection surface of the dichroic prism 53 is the separation surface 53a and thus, there is no need to provide a relay lens 42 (see FIG. 2) for extending an optical path length and a dichroic prism 41 (see FIG. 2) for separating the reflected distance measuring light 46 and the reflected tracking light 52, and it is possible to promote a reduction of the number of components and a reduction of a manufacturing cost.

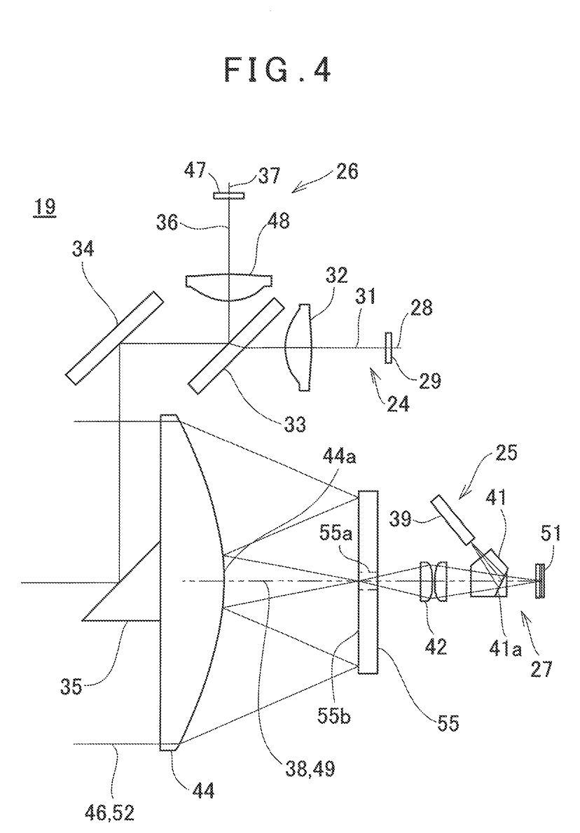

Next, in FIG. 4, a description will be given on a third embodiment of the present invention. It is to be noted that, in FIG. 4, the same components as shown in FIG. 2 are referred by the same symbols, and a description thereof will be omitted.

In the third embodiment, instead of the reflection mirror 45 (see FIG. 2) in the first embodiment, a reflection mirror 55 is provided, and a light receiving reflection prism 43 (see FIG. 2) is omitted.

Regarding the reflection mirror 55, a hole 55a through which the reflection mirror 55 is penetrated is formed at a center part, and parts other than the center part is a reflection surface 55b and functions as a first reflection part. The hole 55a is located on a light receiving optical axis 38 and a tracking light receiving optical axis 49 which transmit a light receiving lens 44 and has a diameter through which a reflected distance measuring light 46 and a reflected tracking light 52 sequentially reflected by the reflection surface 55b and a reflection surface 44a is capable of passing.

Further, on the light receiving optical axis 38 and the tracking light receiving optical axis 49 passing through the hole 55a, a relay lens 42, a dichroic prism 41, a tracking photodetector 51 are provided, and on a reflection optical axis of a separation surface 41a of the dichroic prism 41, a light receiving fiber 39 is provided. The other configurations are similar to those in the first embodiment.

In the third embodiment, too, since the reflected distance measuring light 46 and the reflected tracking light 52 are reciprocatingly reflected a plurality of times along the receiving light optical axis 38 and the tracking light receiving optical axis 49 between the light receiving lens 44 and the reflection mirror 55, optical path lengths of the reflected distance measuring light 46 and the reflected tracking light 52 are ensured.

Therefore, since it is possible to reduce a length in a direction of the light receiving optical axis 38 (the tracking light receiving optical axis 49) of a distance measuring light receiving module 25 and a tracking light receiving module 27, it is possible to promote a size reduction of an optical system of a distance measuring module 19, and it is possible to promote a size reduction and a weight reduction of an entire surveying instrument 1.

Further, since a light receiving reflection prism 43 (see FIG. 2) for further deflecting the reflected distance measuring light 46 and the reflected tracking light 52 sequentially reflected by the reflection surface 55b and the reflection surface 44a is not needed, it is possible to further reduce the number of components and to promote a reduction of a manufacturing cost.

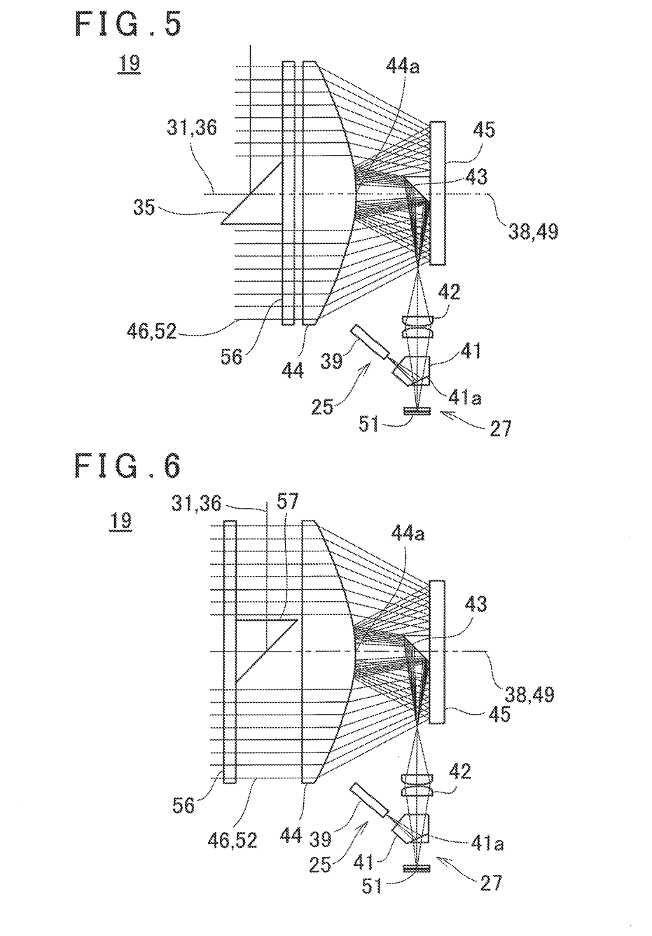

Next, in FIG. 5, a description will be given on a fourth embodiment of the present invention. It is to be noted that, in FIG. 5, the same components as shown in FIG. 2 are referred by the same symbols, and a description thereof will be omitted.

In the fourth embodiment, a plane-parallel plate 56 is provided between a light receiving lens 44 and a scanning mirror 15 (see FIG. 2), and on the scanning mirror 15 side of the plane-parallel plate 56, that is, to a surface on an object side, a reflection prism 35 is joined. The other configurations are similar to those in the first embodiment.

The plane-parallel plate 56 is a glass plate with a predetermined plate thickness, for instance, and is disposed such that an incident surface and a projection surface orthogonally cross a light receiving optical axis 38 and a tracking light receiving optical axis 49.

In the fourth embodiment, since the reflection prism 35 is provided on a surface on the scanning mirror 15 side of the plane-parallel plate 56, a distance measuring light 31 and a tracking light 36 are not incident into the plane-parallel plate 56, and only the reflected distance measuring light 46 and the reflected tracking light 52 are incident into the plane-parallel plate 56 and are transmitted.

In the fourth embodiment, since the reflection prism 35 is joined to the plane-parallel plate 56, there is no need to directly join the reflection prism 35 to the light receiving lens 44. Therefore, since it is possible to reduce a restriction when the light receiving lens 44 is manufactured, it is possible to produce the light receiving lens 44 easily.

Further, in the fourth embodiment, too, since the reflected distance measuring light 46 and the reflected tracking light 52 are reciprocatingly reflected a plurality of times between the light receiving lens 44 and the reflection mirror 45, it is possible to reduce the lengths of a distance measuring light receiving module 25 and a tracking light receiving module 27 in a direction of the light receiving optical axis 38, and it is possible to promote a size reduction of an optical system of the distance measuring module 19 and a size reduction of an entire surveying instrument 1.

Next, in FIG. 6, a description will be given on a fifth embodiment of the present invention. It is to be noted that, in FIG. 6, the same components as shown in FIG. 5 are referred by the same symbols, and a description thereof will be omitted.

In the fifth embodiment, a reflection prism 57 such as a triangular prism or the like having a reflection surface inside, for instance, is a deflection optical member. Further, the reflection prism 57 is joined to a surface on a light receiving lens 44 side of a plane-parallel plate 56, and incident surfaces of a distance measuring light 31 and a tracking light 36 are disposed such that the incident surfaces orthogonally cross a distance measuring optical axis 28 and a tracking optical axis 37, for instance. The other configurations are similar to those in the fourth embodiment. It is to be noted that it may be constituted such that the reflection Prism 57 has an incident surface tilted by approximately 0.5° to 3° with respect to the distance measuring optical axis 28 and the tracking optical axis 37, and a return light is prevented.

In the fifth embodiment, since the reflection prism 57 is provided on a surface on a side of the light receiving lens 44 of the plane-parallel plate 56, the distance measuring light 31 and the tracking light 36 transmitted through an inside of the reflection prism 57 and reflected, are transmitted through the plane-parallel plate 56, and a reflected distance measuring light 46 and a reflected tracking light 52 are also transmitted through the plane-parallel plate 56. It is to be noted that it is constituted such that, regarding the distance measuring light 31 and the tracking light 36, spread angles are slightly diverged in a process of being transmitted through the plane-parallel plate 56.

In the fifth embodiment, too, since the reflection prism 57 is joined to the plane-parallel plate 56, and there is no need to directly join the reflection prism 57 to the light receiving lens 44, it is possible to reduce a restriction when the light receiving lens 44 is manufactured, and it is possible to produce the light receiving lens 44 easily.

Further, since the reflected distance measuring light 46 and the reflected tracking light 52 are reciprocatingly reflected a plurality of times between the light receiving lens 44 and a reflection mirror 45, it is possible to reduce lengths of a distance measuring light receiving module 25 and a tracking light receiving module 27 in a direction of a light receiving optical axis 38, and it is possible to promote a size reduction of an optical system of a distance measuring module 19 and a size reduction of an entire surveying instrument 1.

It is to be noted that, in the first embodiment to fifth embodiment, it is constituted such that a distance measuring module 19 has a distance measuring unit and a tracking unit provided coaxially, and a distance measurement and a tracking are performed in parallel, but it may be so constituted that the distance measuring module 19 has only a distance measuring unit.

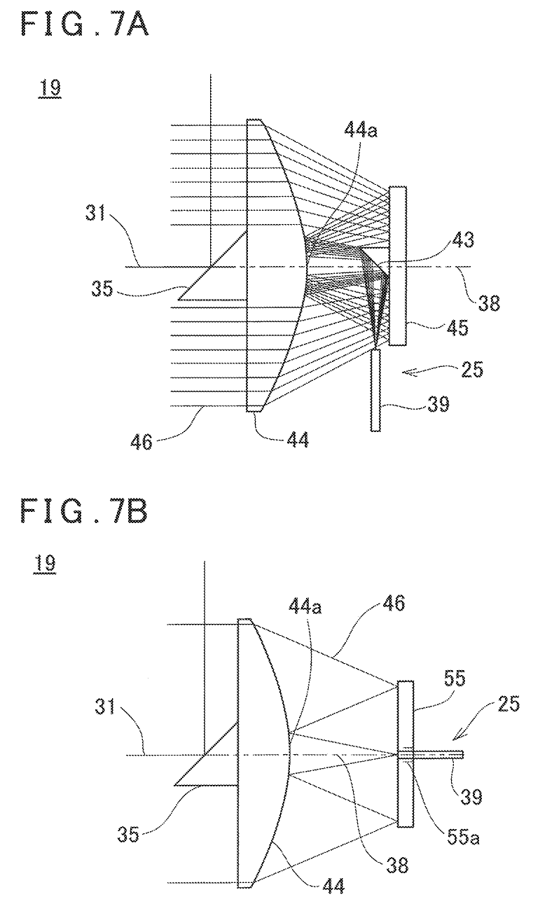

For instance, FIG. 7A illustrates a first variation. The first variation is a variation of the first embodiment. In the first variation, a light receiving fiber 39 is disposed such that a light receiving end surface is located at a light focusing position of a reflected distance measuring light 46 reflected by a light receiving reflection prism 43, and a relay lens 42, a dichroic prism 41 and the like are omitted. In the first variation, too, it is possible to obtain an effect equal to that of the first embodiment. It is to be noted that in FIG. 7A, when the light receiving reflection prism 43 is a dichroic prism 53 (see FIG. 3), it makes a variation of the second embodiment, and it is possible to obtain an effect equal to that of the second embodiment.

Further, FIG. 7B illustrates a second variation. The second variation is a variation of the third embodiment. In the second variation, a light receiving fiber 39 is disposed such that a light receiving end surface is located at a light focusing position of a reflected distance measuring light 46 transmitted through a light receiving lens 44 such as in a hole 55a of a reflection mirror 55, for instance, and a relay lens 42, a dichroic prism 41 and the like are omitted. In the second variation, too, it is possible to obtain an effect equal to that of the third embodiment.

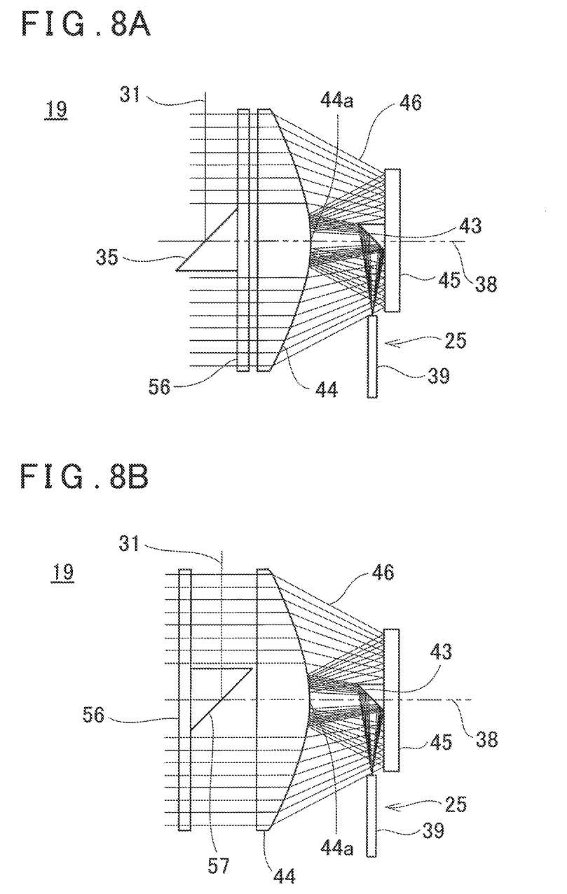

Further, FIGS. 8A and 8B illustrate a third variation and a fourth variation, respectively. The third variation is a variation of the fourth embodiment, and the fourth variation is a variation of the fifth embodiment. In both the third variation and the fourth variation, a light receiving fiber 39 is disposed such that a light receiving end surface is located at a light focusing position of a reflected distance measuring light 46 reflected by a light receiving reflection prism 43, and a relay lens 42, a dichroic prism 41 and the like are omitted. In the third variation and the fourth variation, too, it is possible to obtain an effect equal to those of the fourth embodiment and the fifth embodiment, respectively.

Further, in the first embodiment to the third embodiment and the first variation, the second variation, an incident surface of the light receiving lens 44, that is, a surface on the scanning mirror 15 side is planar, and the reflection prism 35 is joined to the plane, but a surface shape of the incident surface and a mounting method of the reflection prism 35 are not limited to above.

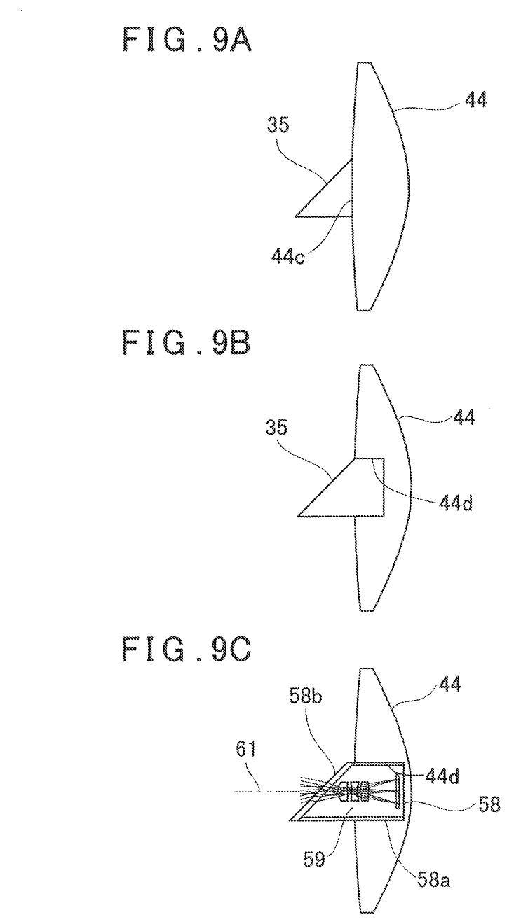

For instance, as shown in FIG. 9A, it may be so constituted that an incident surface of the light receiving lens 44 is a curved surface such as an aspherical surface, an annular aspherical surface, an axially symmetrical free curved surface or the like. In this case, at a center part of the incident surface, a planar part 44c is formed, and to the planar part 44c, the reflection prism 35 is joined.

Alternatively, as shown in FIG. 9B, it may be so constituted that a hole 44d is drilled at a center part of the incident surface, and the reflection prism 35 is joined to the hole 44d.

Further, those to be joined to the light receiving lens 44 are not limited to the reflection prism 35. For instance, as shown in FIG. 9C, a cylindrical mirror 58 as a deflection optical member may be provided.

The cylindrical mirror 58 has a hollow cylinder part 58a and a dichroic mirror 58b as a reflection surface and is joined to the hole 44d. The dichroic mirror 58b has an optical characteristic that transmits a visible light and reflects a near-infrared light, that is, the distance measuring light 31 and the tracking light 36.

Further, inside the cylinder part 58a, an image pickup module 59 is provided, and the dichroic mirror 58b and the image pickup module 59 are disposed such that an image pickup optical axis 61 of the image pickup module 59 matches the distance measuring optical axis 28 and the tracking optical axis 37 deflected by the dichroic mirror 58b. That is, the image pickup module 59 is disposed coaxially with a distance measuring unit and a tracking unit.

As a deflection optical member, when the cylindrical mirror 58 in which the image pickup module 59 is incorporated is used, it is possible to obtain an image by an external light incident coaxially with the reflected distance measuring light 46 and the reflected tracking light 52, and further, to the distance measurement and the tracking, it is possible to perform an imaging and a sighting in parallel.

It is to be noted that, in the first embodiment to the fifth embodiment and in the first variation to the fourth variation, the case in which the focal distance f of the light receiving lens 44 is set to f = 110 mm, an objective effective diameter to ϕ50 mm was explained. On the other hand, it is needless to say that it is also possible to apply a light receiving lens having a focal distance “f” or an objective effective diameter “ϕ” other than that to each of the embodiments and each of the variations, and it is needless to say that an optical design is changed as appropriate in accordance with the focal distance “f” or the objective effective diameter “ϕ”.

1. A surveying instrument comprising: a distance measuring light projecting module which projects a distance measuring light to an object, a distance measuring light receiving module having a light receiving module which receives a reflected distance measuring light from said object, and an arithmetic control module which controls said distance measuring light projecting module and calculates a distance to said object based on a light receiving result of said reflected distance measuring light with respect to said light receiving module, wherein said distance measuring light receiving module has a light receiving lens which focuses said reflected distance measuring light, and a reflection mirror provided oppositely to said light receiving lens, a reflection surface is formed at a center part of a surface opposing said reflection mirror of said light receiving lens, and said reflected distance measuring light transmitted through said light receiving lens is reciprocatingly reflected by said reflection mirror and said reflection surface along an optical axis of said reflected distance measuring light.

2. The surveying instrument according to claim 1, further comprising: a light receiving reflection prism provided on said reflection mirror, wherein said light receiving reflection prism is configured to deflect said reflected distance measuring light reflected by said reflection surface at a right angle or substantially at a right angle.

3. The surveying instrument according to claim 1, wherein said reflection mirror further has a hole formed at a center part, and said reflected distance measuring light reflected by said reflection surface passes through said hole.

4. The surveying instrument according to claim 1, further comprising: a scanning mirror which rotationally irradiates said distance measuring light, a deflection optical member which deflects said distance measuring light such that said distance measuring light coincides with a rotation axis of said scanning mirror, and a plane-parallel plate provided on a side closer to said scanning mirror than said light receiving lens, wherein said deflection optical member is configured to be joined to a surface on a side of said scanning mirror of said plane-parallel plate.

5. The surveying instrument according to claim 1, further comprising: a scanning mirror which rotationally irradiates said distance measuring light, a deflection optical member which deflects said distance measuring light such that said distance measuring light coincides with a rotation axis of said scanning mirror, and a plane-parallel plate provided closer to a side of said scanning mirror than said light receiving lens, wherein said deflection optical member is configured to be joined to a surface on a side of said light receiving lens of said plane-parallel plate.

6. The surveying instrument according to claim 2, further comprising: a tracking light projecting module which projects a tracking light to said object coaxially with said distance measuring light and a tracking light receiving module having a tracking photodetector which receives a reflected tracking light reflected from said object coaxially with said reflected distance measuring light, wherein a dichroic prism having a separation surface which separates said reflected distance measuring light and said reflected tracking light is disposed on a reflection optical axis of said light receiving reflection prism.

7. The surveying instrument according to claim 2, further comprising: a tracking light projecting module which projects a tracking light to said object coaxially with said distance measuring light and a tracking light receiving module having a tracking photodetector which receives a reflected tracking light reflected from said object coaxially with said reflected distance measuring light, wherein said light receiving reflection prism is a dichroic prism having a separation surface which separates said reflected distance measuring light and said reflected tracking light.

8. The surveying instrument according to claim 3, further comprising: a tracking light projecting module which projects a tracking light to said object coaxially with said distance measuring light and a tracking light receiving module having a tracking photodetector which receives a reflected tracking light reflected from said object coaxially with said reflected distance measuring light, wherein a dichroic prism having a separation surface which separates said reflected distance measuring light and said reflected tracking light is disposed on optical axes of said reflected distance measuring light and said reflected tracking light passing through said hole.

9. The surveying instrument according to claim 1, further comprising: a scanning mirror which rotationally irradiates said distance measuring light and a deflection optical member which deflects said distance measuring light such that said distance measuring light coincides with a rotation axis of said scanning mirror, wherein a planar part is formed at a center part of an incident surface of said light receiving lens, and said deflection optical member is joined to said planar part.

10. The surveying instrument according to claim 1, further comprising: a scanning mirror which rotationally irradiates said distance measuring light and a deflection optical member which deflects said distance measuring light such that said distance measuring light coincides with a rotation axis of said scanning mirror, wherein a hole is formed at a center part of an incident surface of said light receiving lens, and said deflection optical member is joined to said hole.

11. The surveying instrument according to claim 10, wherein said deflection optical member is a cylindrical mirror having a cylinder part in which an image pickup module having an image pickup optical axis which is coaxial with said distance measuring light is incorporated and a dichroic mirror which reflects said distance measuring light and transmits a visible light.
